(19) United States
(12) Patent Application Publication
(10) Pub. No.: US 2016/0162990 A1
(43) Pub. Date: Jun. 9, 2016

(54) ENRICHED MARKET DATA GENERATION AND REPORTING

(71) Applicant: Chicago Mercantile Exchange Inc., Chicago, IL (US)

(72) Inventors: Bernard Hosman, Amsterdam (NL); Paul J. Callaway, Chicago, IL (US); Pearce Peck-Walden, Chicago, IL (US)

(21) Appl. No.: 14/959,621

(22) Filed: Dec. 4, 2015

Related U.S. Application Data
(60) Provisional application No. 62/088,051, filed on Dec. 5, 2014.

(51) Int. Cl. G06Q 40/04

(52) U.S. Cl. CPC G06Q 40/04

(57) ABSTRACT

Systems and methods are provided for determining enhanced price-level market data and/or enhanced order-level market data. To determine the enhanced price-level market data and/or enhanced order-level market data an order monitoring device may be configured to monitor one or more orders placed at an exchange, analyze information corresponding to the one or more monitored orders to determine whether an order, or partial order, was canceled without being matched, and generate the enhanced price-level market data and/or enhanced order-level market data based on the information associated with the canceled orders.

This application claims priority to Provisional Application, U.S. Ser. No. 62/088,051, filed Dec. 5, 2014 which is incorporated herein by reference in its entirety.

### FIELD OF THE INVENTION

This disclosure relates generally to improving market data reporting. More particularly, aspects of the invention relate to transparently and efficiently capturing and/or generating market data using orders that do not change the state of the order book.

### BACKGROUND

Exchanges are typically associated with clearing houses that are responsible for settling trading accounts, clearing trades, collecting and maintaining performance bond funds, regulating delivery and reporting trading data. Clearing is the procedure through which the clearing house becomes buyer to each seller of a contract, and seller to each buyer, and assumes responsibility for protecting buyers and sellers from financial loss by assuring performance on each contract. This is effected through the clearing process, whereby transactions are matched.

Participants can submit orders to add, modify or delete orders in a central order book. Exchanges then produce and transmit market data that reflects order submission and trade match activity. For example, in markets that are aggregated by price level, market data describes the respective changes to the total number of contracts available at the respective price levels. When an exchange, or an associated clearinghouse, matches an incoming or modified order with one or more opposing resting order(s), it produces market data detailing the price and the number of contracts that traded.

### SUMMARY OF THE INVENTION

Historically, market data was only created and broadcast when there was a change made to the order book. For some order types when an order is not filled, the order is canceled. As such, the order book is not changed, so there is technically no market data to report. Such orders may include a fill and kill (FAK) order, a fill or kill (FOK) order, an immediate or cancel (IOC) order and/or the like. In such cases, such as with a rejected FAK, the existence of the rejected FAK is information that is valuable to the market. As such, a system and method for efficiently capturing and/or creating market data for orders that do not change the state of the order book is desirable.

Aspects of the disclosure discussed herein overcome at least some of the problems and/or limitations of the existing systems by providing systems and methods for capturing and/or creating market data based, at least in part, on rejected and/or canceled unfilled orders. By improving transparency of reporting, the systems and methods discussed herein allow one or more devices to more accurately and efficiently calculate and/or report market data associated with aggressive liquidity by better determining a supply demand curve associated with market liquidity.

In many cases, Exchanges may offer a range of order types outside of the regular “add”, “modify” and “delete” order types of which the aforementioned FAK or IOC orders are examples. In an illustrative example corresponding to FAK orders, upon receipt of an FAK order, the matching engine may match the order like a regular order, such as by matching the incoming or modified FAK order with one or more opposing resting orders. Any unmatched remaining quantity may be automatically deleted from the system. This deletion is a characteristic feature of the FAK order type. For a number of reasons, information relating to a canceled portion of an FAK order was not included in market data calculations and, therefore, remains invisible to the market at large. However, by incorporating canceled FAK and other similar order types, more accurate market data may be more efficiently and transparently provided to market participants while optimizing the use of computer resources.

In other embodiments, the present invention can be partially or wholly implemented on a computer-readable medium, for example, by storing computer-executable instructions or modules, or by utilizing computer-readable data structures.

Of course, the methods and systems of the above-referenced embodiments may also include other additional elements, steps, computer-executable instructions, or computer-readable data structures. In this regard, other embodiments are disclosed and claimed herein as well.

The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

The present invention may take physical form in certain parts and steps, embodiments of which will be described in detail in the following description and illustrated in the accompanying drawings that form a part hereof, wherein:

FIGS. 1 and 2 show computer network systems that may be used to implement aspects of the present invention.

FIG. 3 shows an illustrative process for matching and publishing matched and rejected orders according to aspects of the present disclosure.

FIG. 4 shows an illustrative method for transparently and efficiently determining enriched market data.

### DETAILED DESCRIPTION

The disclosure relates to methods and systems for processing trade order messages submitted by market participants. As discussed above, most exchanges offer a range of order types in addition to add, modify and delete orders. One type of order is the Fill and Kill (FAK), also referred to as Immediate or Cancel (IOC). Upon receipt of an FAK order, the matching engine performs the following steps:

(1) If the exchange is able to match he incoming FAK order, or at least a portion of the incoming FAK order, the exchange matches the appropriate portion of the resting order like any regular aggressing order;

(2) Any unmatched portion of the FAK orders is automatically deleted from the system. This is the special characteristic of the FAK.

Many existing systems do not generate market data based on orders that undergo the automatic deletion of step 2. As such, rejected FAKs may not be represented to market participants in market data feeds. As a general matter, whether there were one or more participants interested in a trade is relevant information to market participants, but much of that information is not currently being clearly represented by market data, particularly with respect to FAK orders. In some cases, a financial market may provide optional information, such as a summary indicator, to identify volume information associated with deleted IOC orders within a specified time (e.g., about 10 ms, about 20 ms, etc.) of a trade triggered by an IOC order. For example, during the specified time after a triggered trade, IOC orders (e.g., orders at an equal or higher price of the triggered trade) may be combined upon deletion. In some cases, the information associated with the deleted IOC orders may only be associated with a specified order quantity and/or a specified business unit, such as orders associated with a same identifier. Use of FAK orders may often be quite common, resulting in difficulty for market participants to accurately determine the aggressive demand for a trade, even when using an summary indicator as discussed above. In other words, existing market data and existing volume information provided to market participants does not always accurately reflect a true aggregate demand for a trade.

Historically, market data was only created and broadcast when there was a change made to the order book. Accordingly, as in the case of a rejected full or partial FAK order or similar orders, there is no change to the order book and so there is technically no market data to report. However, the existence of a rejected FAK order is information that may be valuable to the market as a whole and market participants, in particular. As such, aspects of the embodiments of the systems and method discussed herein correspond to capturing and/or creating market data for orders that do not change the state of the order book.

The systems and methods discussed herein improve the efficiency and effectiveness of the computing devices that may be used to formulate market data and/or otherwise facilitate a pricing discovery process by providing information corresponding to automatically deleted orders that would have matched had there been an opposing resting order. For example, rather than expending computing resources estimating and/or otherwise predicting a number of automatically canceled orders, a system may generate price-level aggregated market date and/or order-level market data associated with automatically canceled orders, such as FAK or other similar orders. The price-level information may be generated by the system and correspond to one or more of a side, a size, and the price of each individual automatically rejected order (e.g., an FAK order) and the order-level market information may be generated by the system to correspond to creating an add and a delete to the order book with an identifier showing that these add and delete events occurred as an atomic unit. The systems and methods discussed herein may be applicable to both real-time and historical market data, for which the implementation would be the same. Further, these systems and methods may be applicable to any limit order market including, but not limited to futures, options and equities markets.

In an illustrative example, two participants may identify a same or similar opportunity in the market. As such, each participant may initiate an order, such as an FAK order that may have the same, or similar, parameters. Accordingly, an order communicated by one of the two participants may reach the exchange first and, thereby, is matched by the matching engine. Accordingly, the other market participant's order arrives at the exchange after the first order and is rejected by the matching engine. In previous systems, information associated with the rejected offer is lost. However, by capturing information associated with the canceled order, market data generating computer systems may generate enhanced market data corresponding to one or both of price-level aggregated market data and order-level market data to facilitate a more robust market environment.

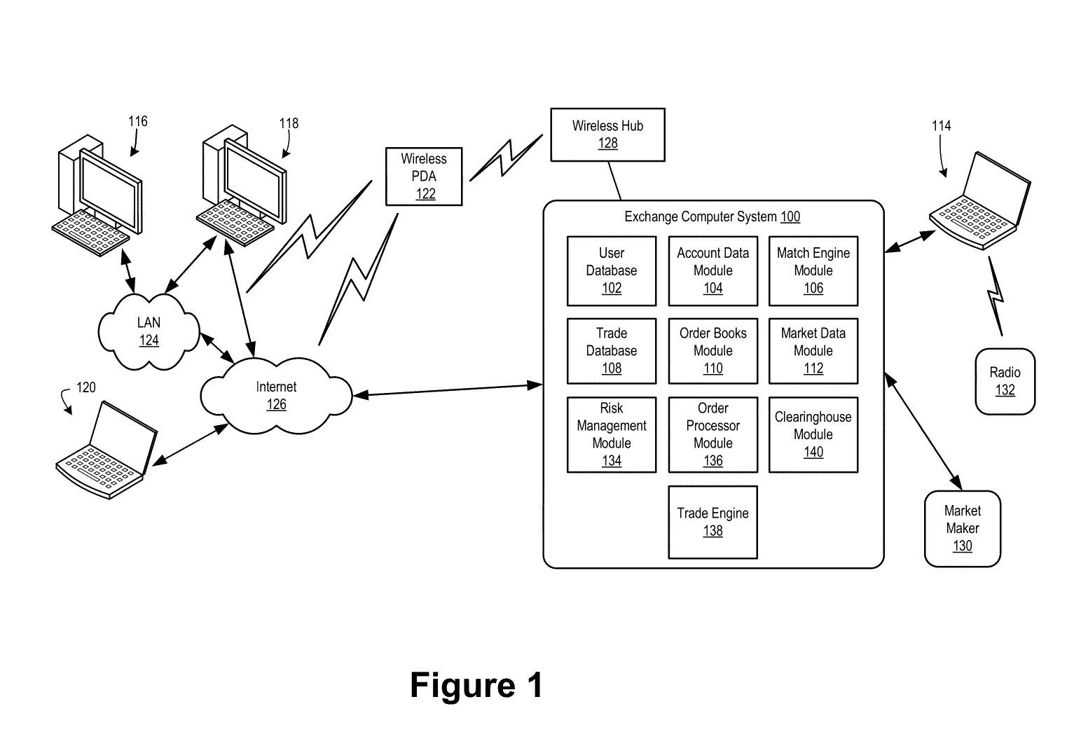

Aspects of the present invention are preferably implemented with computer devices and computer networks that allow users to exchange trading information. An exemplary trading network environment for implementing trading systems and methods is shown in FIG. 1. An exchange computer system 100 receives orders and transmits market data related to orders and trades to users. Exchange computer system 100 may be implemented with one or more mainframe, desktop or other computers. A user database 102 includes information identifying traders and other users of exchange computer system 100. Data may include user names and passwords. An account data module 104 may process account information that may be used during trades. A match engine module 106 is included to match bid and offer prices. Match engine module 106 may be implemented with software that executes one or more algorithms for matching bids and offers. A trade database 108 may be included to store information identifying trades and descriptions of trades. In particular, a trade database may store information identifying the time that a trade took place and the contract price. An order book module 110 may be included to compute or otherwise determine current bid and offer prices. A market data module 112 may be included to collect market data and prepare the data for transmission to users. A risk management module 134 may be included to compute and determine a user's risk utilization in relation to the user's defined risk thresholds. An order processing module 136 may be included to decompose delta based and bulk order types for processing by order book module 110 and match engine module 106.

The trading network environment shown in FIG. 1 includes computer devices 114, 116, 118, 120 and 122. Each computer device includes a central processor that controls the overall operation of the computer and a system bus that connects the central processor to one or more conventional components, such as a network card or modem. Each computer device may also include a variety of interface units and drives for reading and writing data or files. Depending on the type of computer device, a user can interact with the computer with a keyboard, pointing device, microphone, pen device or other input device.

Computer device 114 is shown directly connected to exchange computer system 100. Exchange computer system 100 and computer device 114 may be connected via a T1 line, a common local area network (LAN) or other mechanism for connecting computer devices. Computer device 114 is shown connected to a radio 132. The user of radio 132 may be a trader or exchange employee. The radio user may transmit orders or other information to a user of computer device 114. The user of computer device 114 may then transmit the trade or other information to exchange computer system 100.

Computer devices 116 and 118 are coupled to a LAN 124. LAN 124 may have one or more of the well-known LAN topologies and may use a variety of different protocols, such as Ethernet. Computers 116 and 118 may communicate with each other and other computers and devices connected to LAN 124. Computers and other devices may be connected to LAN 124 via twisted pair wires, coaxial cable, fiber optics or other media. Alternatively, a wireless personal digital assistant device (PDA) 122 may communicate with LAN 124 or the Internet 126 via radio waves. PDA 122 may also communicate with exchange computer system 100 via a conventional wireless hub 128. As used herein, a PDA includes mobile telephones and other wireless devices that communicate with a network via radio waves.

FIG. 1 also shows LAN 124 connected to the Internet 126. LAN 124 may include a router to connect LAN 124 to the Internet 126. Computer device 120 is shown connected directly to the Internet 126. The connection may be via a modem, DSL line, satellite dish or any other device for connecting a computer device to the Internet.

One or more market makers 130 may maintain a market by providing constant bid and offer prices for a derivative or security to exchange computer system 100. Exchange computer system 100 may also exchange information with other trade engines, such as trade engine 138. One skilled in the art will appreciate that numerous additional computers and systems may be coupled to exchange computer system 100. Such computers and systems may include clearing, regulatory and fee systems.

The operations of computer devices and systems shown in FIG. 1 may be controlled by computer-executable instructions stored on computer-readable medium. For example, computer device 116 may include computer-executable instructions for receiving order information from a user and transmitting that order information to exchange computer system 100. In another example, computer device 118 may include computer-executable instructions for receiving market data from exchange computer system 100 and displaying that information to a user.

Of course, numerous additional servers, computers, handheld devices, personal digital assistants, telephones and other devices may also be connected to exchange computer system 100. Moreover, one skilled in the art will appreciate that the topology shown in FIG. 1 is merely an example and that the components shown in FIG. 1 may be connected by numerous alternative topologies.

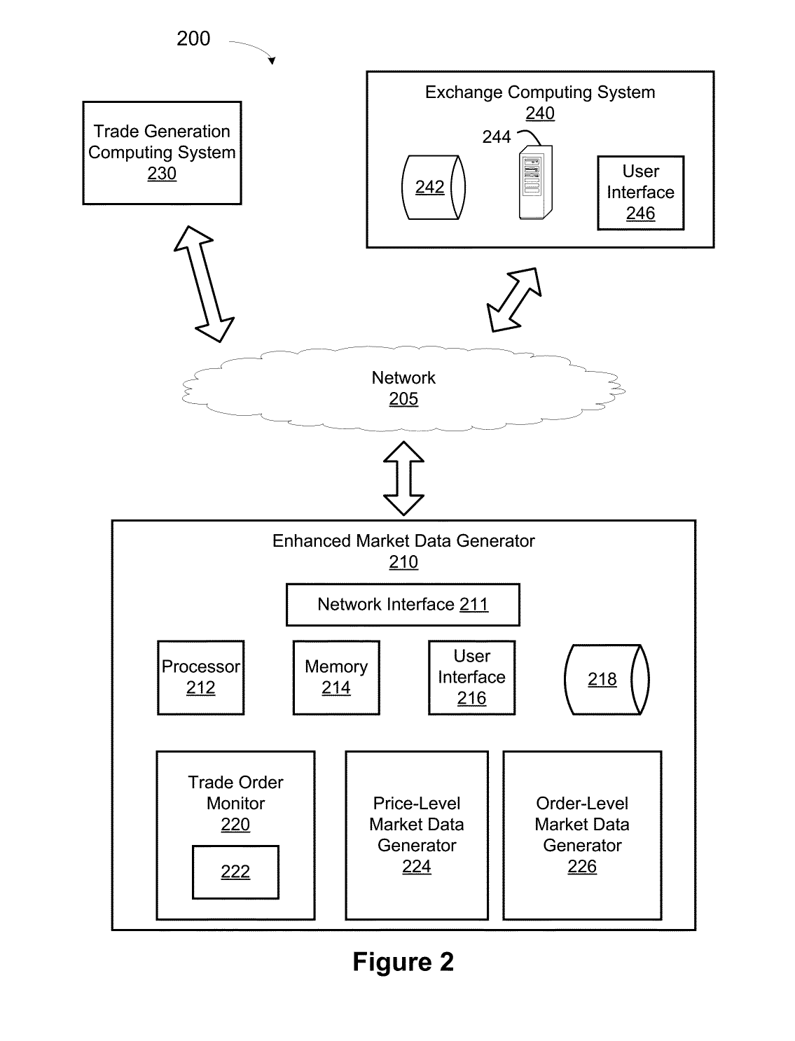

FIG. 2 shows an illustrative system for processing one or more trades, such as an FAK order, according to some embodiments. For example, the system 200 may include an enhanced market data generator 210 that may be communicatively coupled to one or more of a trade generation computing systems (e.g., the trade generation computing system 230 or other order entry system accessible by a trader) and an exchange computing system 240. The enhanced market data generator 210 may be communicatively coupled (e.g., via wired or wireless communication link) to the network 205 via the network interface 211. In some cases, the network interface 211 may facilitate near real-time communication via the network 205 to allow the enhanced market data generator 210 to communicate the generated enhanced market data corresponding to matched orders and/or canceled orders in near real time. In some cases, the trade generation computing system 230 and/or the exchange computing system may include one or more data repositories (e.g., data repository 242), one or more computing devices (e.g., computing device 244), and one or more user interface devices (e.g., user interface 246). The enhanced market data generator 210 may be configured to monitor, or otherwise receive, information about orders placed in a financial market. For example, the enhanced market data generator 210 may monitor trades placed by the trade generation computing system 230, trades received by the exchange computing system and/or trades accepted or rejected by the exchange computing system. In some cases, the enhanced market data generator 210 may determine that one or more orders, or partial orders, placed by a trader may be rejected and/or canceled by the exchange computing system 240, such as by the match engine module 106.

The enhanced market data generator 210 may comprise a device, or multiple devices, configured to process instructions to monitor orders placed in a financial market, determine whether one or more orders, or partial orders, were rejected or canceled, and/or efficiently generate enhanced market data including information corresponding to the rejected or canceled orders. The enhanced market data generator 210 may include one or more processors (e.g., the processor 212), one or more memory devices (e.g., the memory device 214) that may include RAM, ROM, Flash memory, disk drives, DVD drives, and/or the like, one or more user interface devices (e.g., the user interface 216), and/or one or more data repositories 218. Further, the enhanced market data generator 210 may include a trade order monitor 220 configured to monitor via the network 205 one or more orders placed, accepted, rejected and/or canceled at the exchange computing system 240. Information associated with such orders may be stored in a data repository 222. The enhanced market data generator 210 may further include one or both of a price-level market data generator 224 and an order-level market data generator 226. Such market data generators may be configured to efficiently analyze the order information obtained by the trade order monitor and/or stored in the data repository 222. The price level data generator 224 may be configured to process the order information to generate enhanced price level market data reflecting changes to the total number of contracts available at different price levels and including canceled orders associated with the different price levels. For example, the enhanced price level information may include a rejected order type (e.g., an FAK order), a side associated with the rejected order or partial order, a size of the rejected order or partial order, and/or a price associated with the rejected order or partial order. Similarly, the order-level market data generator 226 may be configured to process the order information to generate enhanced order-level market data comprising at least including an “add” and a “delete” to an order book, where the add and delete are combined to show that these events occurred as a single atomic unit. These add and delete commands may also be associated with side, price, and size information. In some cases, size information may further include an original order size, a matched order size and a rejected/canceled order size. Once generated the enhanced market data generator 210 may communicate the enhanced market data via the network 205 to make the enhanced market data available to interested parties.

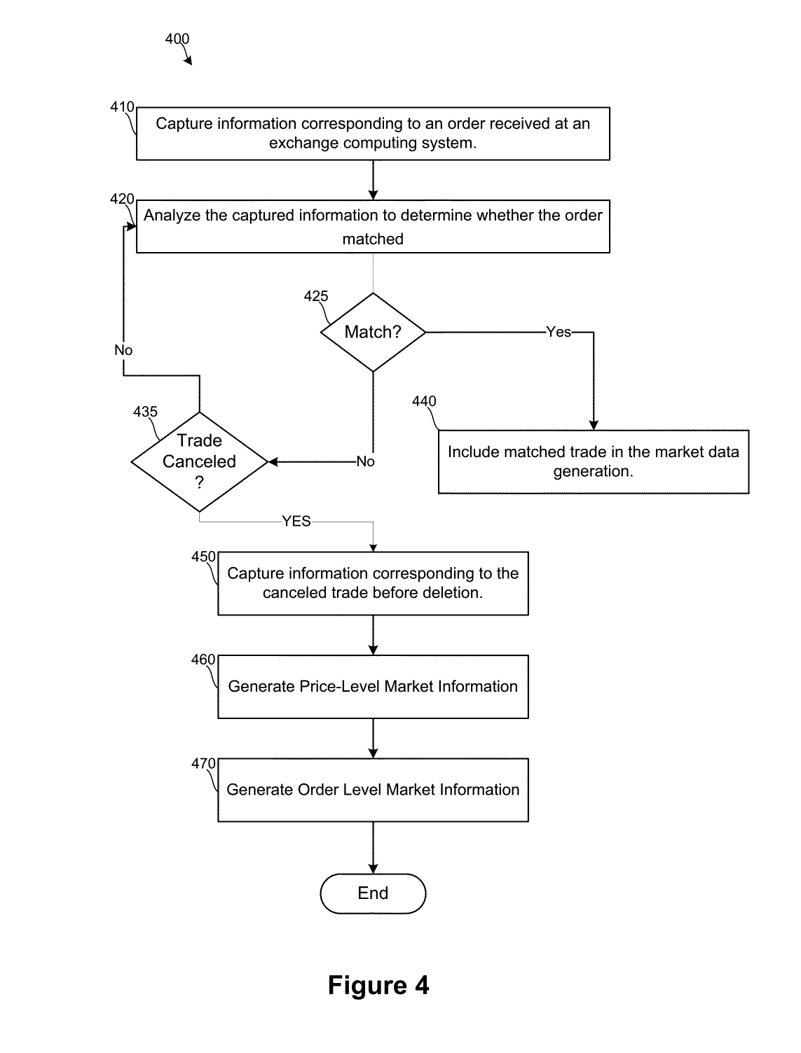

An illustrative method 400 for determining and/or communicating enhanced market data is shown in FIG. 4. For example, the method 400 may begin at 410 by the enhanced market data generator 210, or other such device, capturing information corresponding to an order received at an exchange computing system 240. At 420, the enhanced market data generator 210 may analyze the captured information to determine whether the order matched in the exchange computing system 240. If the order or a partial order was determined to be matched at 425, then the enhanced market data generator 210 may include information corresponding to the matched trade in the enhanced market data generation process by one or more of the price-level market data generator 224 and/or the order-level market data generator 226.

If the order or partial order was determined not to have matched at 425, the enhanced market data generator 210 may determine whether the order or partial order was canceled at 435. If not, the enhanced market data generator 210 may then wait for a period of time or an event before analyzing the captured information, at 420. In some cases, the enhanced market data generator 210 may immediately analyze the information to determine whether the order matched. If the order, or partial order, was determined to have matched at 435, the enhanced market data generator 210 may capture information corresponding to the canceled trade before the trade is deleted from the system at 450, and generate the enhanced price-level market information via the price-level market data generator 224 and/or generate the enhanced order-level market data by the order-level market data generator 226 at 460 and 470, respectively. In some cases, the enhanced market data generator 210 may communicate the enhanced market data (e.g., the price-level market data, the enhanced order-level market data, or both).

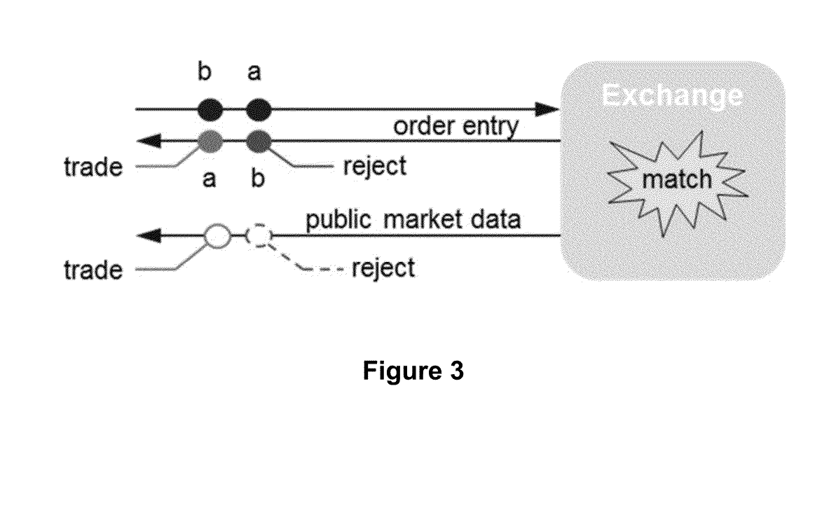

In an illustrative example of FIG. 3, at least two participants, e.g., participant a and participant b, may identify a same or similar opportunity in the market. As such, each participant may initiate an order, such as an FAK order that may have the same, or similar, parameters. Accordingly, an order communicated by a may reach the exchange first and, thereby, is matched by the matching engine. Accordingly, the other market participant's order (e.g., b's order) arrives at the exchange after the first order and is rejected by the matching engine. In previous systems, information associated with the rejected offer is lost. However, by capturing information associated with the canceled order, market data generating computer systems may generate enhanced market data corresponding to one or both of price-level aggregated market data and order-level market data to facilitate a more robust market environment.

The present invention has been described in terms of preferred and exemplary embodiments thereof. Numerous other embodiments, modifications and variations within the scope and spirit of the invention will occur to persons of ordinary skill in the art from a review of this disclosure. For example, aspects of the invention may be used to process and communicate data other than market data.

We claim:

1. A method comprising:
monitoring, by an exchange monitoring computing device via a communications network, a status of a plurality of trades placed with a financial exchange;
determining, by the exchange monitoring device, whether one or more of the plurality of orders was deleted as being unmatched; and
generating, by the exchange monitoring device, enhanced market information that is enhanced by information corresponding to the one or more trades that were deleted as being unmatched, wherein the enhanced market information comprises a visual indication of one or more trades that were matched and a visual indication of the one or more orders that were deleted without being matched.

2. The method of claim 1 comprising:
presenting, by a display device, the enhanced market information to a user via a user interface.

3. The method of claim 1 wherein monitoring the plurality of trades placed with the financial exchange comprises:
identifying, by the exchange monitoring device, a plurality of fill and kill (FAK) orders placed on the financial exchange;
matching, by the exchange monitoring device, at least a portion of each FAK order to a resting order; and
deleting, by the exchange monitoring device, an unmatched portion of each FAK order.

4. The method of claim 3, wherein the generating the enhanced market information comprises:
generating price-level aggregated market data comprising at least one of an indication of a trade side, a trade size and a trade price corresponding to an unmatched FAK order; and
generating order-level market data comprising an indication that the order was added to an order book and an indication that the order was deleted from the order book.

5. The method of claim 4, comprising:
generating, by a price level market data generator, an add indication corresponding to at least a matched portion of each FAK order and a delete indication corresponding to at least the unmatched portion of each FAK order, wherein the add indication and the delete indication comprise a trade event atomic unit.

6. The method of claim 1, further comprising:
communicating, via a network interface, the enhanced market information comprising a delete indication corresponding to the one or more trades that were deleted as being unmatched.

7. The method of claim 6, wherein the enhanced market information is communicated via the network interface over a network in near real-time.

8. A computing device comprising:
a processor;
one or more memory devices communicatively coupled to the processor and storing instructions that, when executed by the processor, cause the computing device to:
monitor, via a network, trading activity at a financial exchange, the trading activity comprising a plurality of fill and kill (FAK) orders;
analyze each of the plurality of FAK orders to determine whether at least a portion of one or more FAK orders was not matched; and
generate enhanced market information based on the analysis, wherein the enhanced market information comprises information on a placement of an FAK order and the cancellation of the FAK order for each of the plurality of FAK orders that were not matched.

9. The computing device of claim 8 comprising:
a network interface communicatively coupled to a network; and
wherein the one or more memory devices store instructions that, when executed by the processor, cause the computing device to communicate the enhanced market information to a user via the network.

10. The computing device of claim 8, wherein the one or more memory devices store instructions that, when executed by the processor, cause the computing device to
identify, by the trade order monitor, a plurality of fill and kill (FAK) orders placed on the financial exchange;
match, by the trade order monitor, at least a portion of each FAK order to a resting order; and
delete, by the trade order monitor, an unmatched portion of each FAK order.

11. The computing device of claim 8, wherein the one or more memory devices store instructions that, when executed by the processor, cause the computing device to
generate price-level aggregated market data comprising at least one of an indication of a trade side, a trade size and a trade price corresponding to an unmatched FAK order; and
generate order-level market data comprising an indication that the order was added to the order book and an indication that the order was deleted from the order book.

12. The computing device of claim 11, wherein the one or more memory devices store instructions that, when executed by the processor, cause the computing device to:
generate, by a price level market data generator, the add indication corresponding to at least a matched portion of each FAK order and a delete indication corresponding to at least the unmatched portion of each FAK order, wherein the add indication and the delete indication comprise a trade event atomic unit.

13. The computing device of claim 8, further wherein the one or more memory devices store instructions that, when executed by the processor, cause the computing device to:
communicate, via a network interface, the enhanced market data comprising a delete indication corresponding to the one or more trades that were deleted as being unmatched.

14. The computing device of claim 13, wherein the enhanced market data is communicated via the network interface over a network in near real-time.

15. A system comprising:
a communications network;
an exchange computing system communicatively coupled to the communications network; and
an exchange monitoring device communicatively coupled to the exchange computing system via the communications network, wherein the exchange monitoring device comprises a processor and one or more memory devices storing instructions, that when executed by the processor, cause the exchange monitoring device to:
monitor, via a the communications network, trading activity on the exchange computing system, the trading activity comprising a plurality of fill and kill (FAK) orders;
analyze each of the plurality of FAK orders to determine whether at least a portion of one or more FAK orders was not matched; and
generate enhanced market information, for presentation to a user via a display device, based on the analysis, wherein the enhanced market information comprises information on a placement of an FAK order and the cancellation of the FAK order for each of the plurality of FAK orders that were not matched.

16. The system of claim 15 comprising further comprising:
a remote display device communicatively coupled to the communications network; and
wherein the one or more memory devices store instructions that, when executed by the processor, cause the computing device to present to a user the enhanced market information via a user interface screen on the remote display device.

17. The system of claim 15, wherein the one or more memory devices store instructions that, when executed by the processor, cause the exchange monitoring device to
identify a plurality of fill and kill (FAK) orders placed on the financial exchange;
match at least a portion of each FAK order to a resting order; and
delete an unmatched portion of each FAK order.

18. The system of claim 15, wherein the one or more memory devices store instructions that, when executed by the processor, cause the exchange monitoring device to
generate price-level aggregated market data comprising at least one of an indication of a trade side, a trade size and a trade price corresponding to an unmatched FAK order; and
generate order-level market data comprising an indication that the order was added to the order book and an indication that the order was deleted from the order book.

19. The system of claim 18, wherein the one or more memory devices store instructions that, when executed by the processor, cause the exchange monitoring device to:
generate, by a price level market data generator, the add indication corresponding to at least a matched portion of each FAK order and a delete indication corresponding to at least the unmatched portion of each FAK order, wherein the add indication and the delete indication comprise a trade event atomic unit; and
communicate, via a network interface, the enhanced market data comprising a delete indication corresponding to the one or more trades that were deleted as being unmatched.

20. The system, of claim 19, wherein the enhanced market data is communicated via the network interface over a network in near real-time.
